(19) United States
(12) Patent Application Publication
(10) Pub. No.: US 2016/0071047 A1
(43) Pub. Date: Mar. 10, 2016

(54) System And Method For Evaluation Of Problem-Solving Measures And Corrective Actions

(71) Applicant: Carl D. Veley, Houston, TX (US)

(72) Inventor: Carl D. Veley, Houston, TX (US)

(73) Assignee: VPSI CONCEPTS, LLC, Houston, TX (US)

(21) Appl. No.: 14/874,033

(22) Filed: Oct. 2, 2015

Related U.S. Application Data
(62) Division of application No. 11/278,135, filed on Mar. 30, 2006, now abandoned.
(60) Provisional application No. 60/666,359, filed on Mar. 30, 2005.

(51) Int. Cl. G06Q 10/06; G06F 17/30

(52) U.S. Cl. CPC G06Q 10/06393; G06F 17/30386

(57) ABSTRACT

A system and method used for the evaluation of problem-solving measures and corrective actions, including, but not limited to, actions associated with accident prevention, for the purpose of quantifying organizational effectiveness and identifying safety improvement performance.

### CROSS-REFERENCE TO RELATED APPLICATIONS

This application claims the benefit of co-pending U.S. Non-Provisional application Ser. No. 11/278,135, filed Mar. 30, 2006, titled “System and Method for Evaluation of Problem Solving Measures and Corrective Actions,” which claimed the benefit of U.S. Provisional Application No. 60/666,359, filed Mar. 30, 2005, titled “System and Method for Evaluation of Problem Solving Measures and Corrective Actions,” now abandoned, wherein both of these applications are incorporated, in their entireties, herein by this reference.

### STATEMENT OF FEDERALLY SPONSORED RESEARCH OR DEVELOPMENT

This disclosure does not include any federally sponsored research or development.

### BACKGROUND

Safety performance is an increasingly important factor in deciding which bidders get contracts. Companies also make safety performance an important element in selecting employees for promotion, or for termination. The stakes are high, and it is critical that safety performance measurements accurately reflect probability of future accidents. Conventional measurements are proving to be unreliable indicators of the future and can cause contracts to go to bidders with the highest, not lowest, probability of accidents. They punish supervisors and for things companies they cannot control. Additionally, they can unfairly derail the careers of capable employees at all levels.

Conventional safety metrics are variations of frequency and severity calculations that summarize the consequences of accidents rather than summarizing the accidents themselves. These summaries are widely assumed to forecast the future—an invalid assumption for many reasons. As a result, people or entire companies may be punished or rewarded for things they cannot control. For example, assume two crews have identical accidents, but the first crew suffers no injuries and the other crew experiences a fatal injury. Current metrics effectively punish the second crew much more than the first, although injury severity was purely a matter of chance, and was outside the supervisors' control. This method is routinely applied in awarding contracts worth billions of dollars annually. This method of reward and punishment produces a powerful incentive for deception, ranging from creative accounting to falsifying accident statistics.

A total recordable injury or incident rate (TRIR) is popular as a measure of injury frequency. Future injury frequencies are then estimated by assuming they will be about the same as last year, adjusted by extrapolating any apparent up or down trends seen over the past few years.

Conventional safety performance measurements can be grossly misleading because (1) they are susceptible to deceptive record keeping, and (2) they summarize the past and cannot reliably predict the future. Ultimately, all reasons for measuring safety performance are concerns about the future. A company offering a contract worth millions of dollars assumes that bidders with the best past safety performance are least likely to have accidents in the future. This assumption deserves careful examination.

### SUMMARY

A problem solving improvement index is described herein that eliminates these problems. It is based on an objective, highly reliable system of evaluating corrective actions. This system according to the disclosure generates a single number directly indexed to problem solving performance. The system eliminates problems with conventional frequency and severity ratios, and it is proving to be a powerful management tool in many ways.

In particular, described herein is a system for generating a problem solving index, comprising a mechanism for receiving information related to one or more accident reports each containing a description of one or more corrective actions. The system includes a subsystem for respectively rating the accident reports based upon a rated type of the respective corrective actions. The system further includes a processor for calculating a planning index for the accident reports by calculating a weighted average of the rating of accident reports. Further, the processor calculates an awareness index for the accident reports. The processor also calculates an implementation index for the accident reports based upon the number of the implemented corrective actions having a predetermined Type. The processor also calculates the product of the planning index, the awareness index, and the implementation Index. This product is the problem solving index which is an objective index representation of corrective actions taken with respect to the accident reports. The system may then report the calculated problem solving index.

In another embodiment according to the disclosure, the awareness index is automatically adjusted to be within the range of 0.25 and 1.0.

In another embodiment according to the disclosure, the mechanism for respectively rating the accident reports, includes mechanism for presenting a user with one or more questions related to each respective corrective actions. Further a mechanism for receiving responses from the user to the questions. The responses are then reviewed and a Type is designated based upon the responses. The accident report is rated with the greatest type among the respective designated corrective actions.

### BRIEF DESCRIPTION OF THE SEVERAL VIEWS OF THE DRAWING

FIG. 1 is a chart identifying the components of an accident.

FIG. 2 is a flow chart of a typical reporting process.

FIG. 3 is a flow chart of a reporting process according to the disclosure.

FIG. 4 is an example worksheet form for accumulating information used in calculating the problem solving index according to the disclosure.

FIG. 5 is a table showing examples of classifications of corrective action according to the disclosure.

FIG. 6 is another table showing examples of classifications of corrective action according to the disclosure.

FIG. 7 is a table identifying the four types of corrective actions according to the disclosure.

FIG. 8 is a table identifying a weighted average example.

FIG. 9 is a flow chart of an example embodiment of a process for calculating the Problem Solving Index according to the disclosure.

FIG. 10 is an embodiment of system according to the disclosure.

FIG. 11 is a process implemented by the system in FIG. 10, according to the disclosure.

### DETAILED DESCRIPTION OF THE DISCLOSURE

The method and system according to the disclosure of measuring problem solving performance improvement, the Problem Solving Index (vPSI, provides a quantitative evaluation of the corrective actions on accident reports. By quantifying the merits of corrective actions, the vPSI system has major advantages over conventional measurements. It rewards problem solving actions. It also leads to a change in corporate culture and processes.

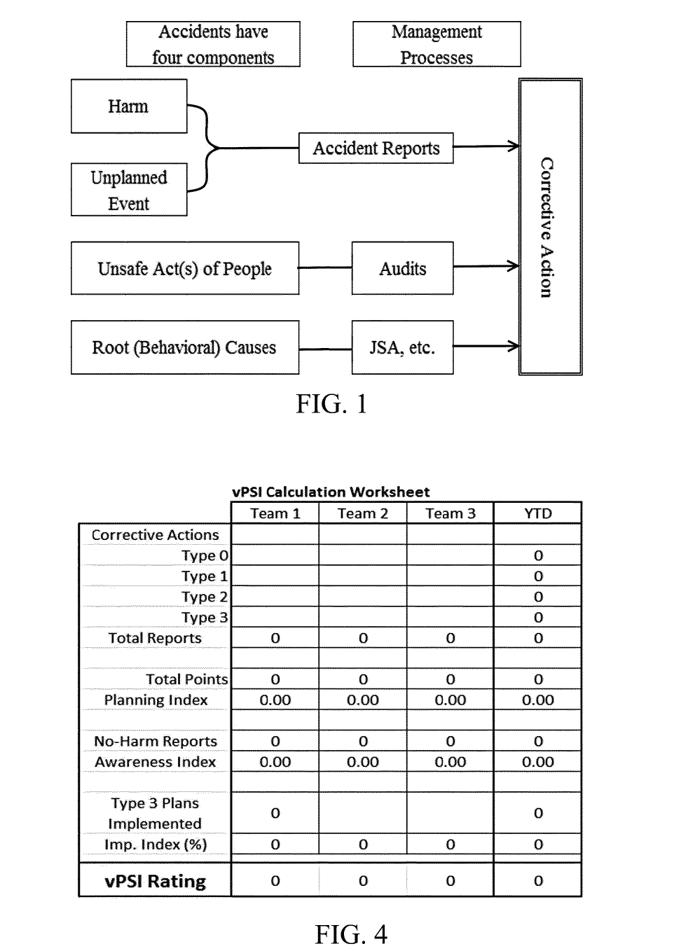

As shown in FIG. 1, all accidents have the following four components:

Harm (injury or damage)

An unplanned event (with potential for causing significant harm, whether harm occurred or not)

Unsafe acts of people (unsafe conditions can always be attributed to one or more unsafe acts of people)

Root causes (the reason(s) for unsafe acts)

By this definition, a broken arm is not an accident; it's an injury, or the result of an accident. Likewise, a fall is always an accident whether it causes injury or not. People often use terms like “near miss” or “incident” when referring to an accident that did not cause significant damage or injury. Such terminology confuses the accident with its consequences. This discussion will define “accident” as any unplanned event with a realistic potential for causing significant harm, whether harm actually occurred or not.

Summaries of harm, events, acts, and causes cannot be used to forecast future performance. Typically, the principal management processes applied to the various accident component steps are Accident Reports, Audits, and Job Safety Analyses (JSAs), or other behavioral control measures. These processes are useful only to the extent that they produce effective corrective actions. Devising and performing a corrective action is the only way to prevent a potential future accident from occurring. Therefore, the effectiveness of corrective actions is the most important item to measure.

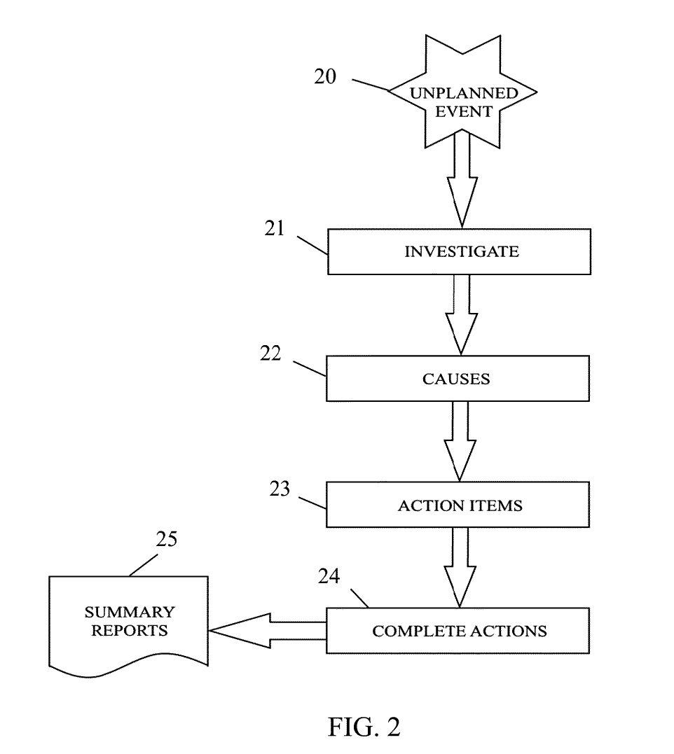

FIG. 2, shows a flow chart of a typical reporting process. An unplanned event 20 occurs resulting in an investigation 21. The investigation 21 determines causes 22 and leads to a list of action items 23. The action items 23 are implemented in step 24 resulting in the creation of summary reports 25. The action items 23 must be implemented otherwise they will have no effect in preventing future accidents.

A quantitative measurement for corrective actions cannot be devised until a qualitative definition of ‘good’ corrective actions is established. In practice, a corrective action is typically judged by simple common sense and then waiting to see if the accident repeats. These approaches are faulty.

Common sense can be misleading when relied upon for devising a corrective action to an incident. By definition, nobody wants an accident to happen, and people involved in accidents normally rely on their common sense to determine what is safe behavior and what is unsafe behavior. Qualitative measurement must evaluate the corrective action not the unsafe behavior.

Waiting to see if an accident happens again can require a very long time. Most unsafe acts do not result in accidents, and people may have performed that unsafe act for 10 years before the accident. If no corrective action is taken at all, another 10 years or more could pass with no accident. Waiting to see if an accident repeats can never prove an action's effectiveness. When an accident repeats, it proves the previous corrective action did not work, but not repeating does not logically prove anything.

Therefore, corrective actions must be judged by other methods. The vPSI measurement system according to the disclosure establishes such a method and system using a classification system based on fundamental definitions for management in general.

The following example shows corrective actions from accident reports submitted by four hypothetical drilling rigs that had identical accidents.

The hypothetical accident: A crew is pulling drill pipe out of the hole after drilling with synthetic oil base mud (SOBM). In this operation, small amounts of SOBM are often spilled, making the rig floor slippery. On each rig, a man with SOBM on his boots slips and falls on the rig floor stairs. Reports filed by rig foreman state the following solutions for each rig:

RIG A: Cleaned drilling mud off stairs and rig floor.

Rig B: Reminded everyone in pre-shift safety meetings to watch out for slippery, muddy boots when pulling drill pipe.

Rig C: Instructed a person to put clean mats at stair landings and wherever people need them to clean their boots.

Rig D: Modified JSA for pulling drill pipe to include assigning someone to distribute clean mats at the start of each shift.

In this case, one might intuitively conclude that Rig D has the lowest probability of having another man fall down stairs next week, next month, or next year. Theirs is the only corrective action that changes things in the future. One might also intuitively suspect that Rig B's corrective action is the least effective because they simply reminded people of something they already knew and did not change anything. Ranking corrective actions from Rigs A and C is less clear.

These actions amount to single data points from each rig, and they do not identify which rig was the most or least safe before the accident. It would not be logical to conclude which of these rigs would be safest after the accident, if these were the only data points available. However, if supervisors on these rigs have a pattern of solving problems with corrective actions like those in the foregoing example, then perhaps we can reach more general conclusions.

Suppose on one of these rigs the person who fell was unhurt, two others who fell suffered only minor injuries, and the fourth person has been permanently crippled from spinal damage. The assessment of the corrective actions' effectiveness does not change, regardless of which injury goes with which rig. We might inductively conclude that effectiveness of corrective actions is never determined by injury severity. As mentioned earlier, severe injury can cause crew members to be extra alert for similar unsafe acts or conditions, but that is a separate phenomenon that occurs independently of management's corrective actions.

The system can be constructed beginning with some more fundamental definitions. Specifically, the following four definitions apply:

1. Management is making things happen according to a plan.

2. An accident is an unplanned event with a potential for causing harm.

3. A plan is a prearranged schedule of events leading to attaining some objective.

4. A corrective action is a plan by which work is managed.

Definition 2 can be reworded to state that an accident is something that happened not according to plan. Then it combines with definition 1 to form the logical syllogism: Management=accident prevention. This equation suggests that accident prevention is not a separate discipline, and it can be graded, measured, or evaluated by the same methods used to evaluate management.

In definition 3, the term “prearranged” means “caused to happen,” and therefore the corrective action will happen, if it meets the definition for a plan. It will also reduce or eliminate chances of the accident repeating, if it addresses one or more root causes of an accident. These observations suggest that if a means of measuring corrective actions exists, it must be defined in fundamental management theory.

A person can cause something to happen in only two ways: do it himself, or get someone else to do it. It is Direct Action if one does something himself. It is either Supervising or Managing if one delegates someone else to do it. These designations have nothing to do with job titles; they simply describe methods by which one causes things to happen.

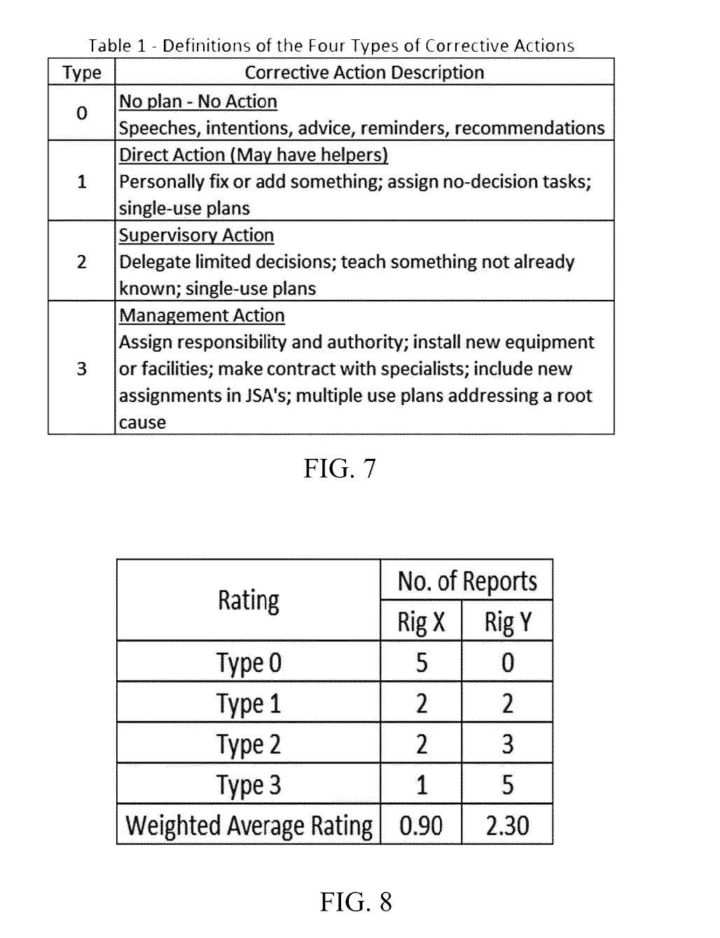

The safety performance measurement system according to the disclosure begins with these understandings. By definition, any corrective action must fit into one of these descriptions or classifications. We select the right type or classification by referring to the Table in FIG. 7.

A Corrective Action must cause must cause a change in the course of events—i.e. something must happen as a result of the action that would not have happened without it. It is impossible to change laws of nature, so any corrective action must be a means in causing one or more changes in the acts of people. Devising corrective actions begins with a clear identification of current and desired acts of people. A corrective action is a prearranged schedule of events leading to attaining some objective. This is also the definition of a “plan” as used herein.

If we apply these definitions to the corrective actions in the previous example, we find an illustration of each of the four types.

Rig A cleaned mud off the stairs. Whether the rig supervisor did it personally or assigned a helper to do it is irrelevant. Cleaning stairs is a task that does not involve significant decision-making. Also, it is a single-use plan that does not cause the stairs to be cleaned in the future. This is a Type 1, or direct action.

Rig B told people about a danger, but they admitted it was a reminder, meaning the employees had been told before, and that knowledge did not prevent the accident. This statement does not meet the definition of a plan because it does not prearrange an event that will prevent the accident. It is a Type 0.

Rig C's action could be called a Type 1, but the helper was given some discretion in deciding where to put the mats. So this action is designated as a Type 2.

Rig D produced a Type 3, management action, multi-use plan, provided the JSA is a checklist of assignments and it is used properly. An effective JSA will produce corrective actions that meet the same definitions as any other corrective action.

According to the disclosure a weighted average of the plan types will reflect problem-solving skills Suppose we want to compare two hypothetical rigs that have both turned in 10 accident reports. Further suppose corrective actions on those reports were classified as shown in FIG. 8.

If we had complete confidence in these data, we would conclude that Rig X is more likely than Rig Y to have accidents in the future. Five Type 0 reports suggest that Rig X supervisors tend to state what should happen rather than give a clear plan for how they will cause it to happen. The action plans they do give are generally only short-lived, as shown by four single-use plans (Types 1 and 2) and only one multiple-use Type 3 plan.

Finally, a weighted averages shows that Rig X is more likely to ignore a problem than to correct it, because their net rating is less than 1.0 and Type 1 plans are the minimum for any action at all. Additionally, the probability is high that the single Type 3 plan will soon fade on Rig X. Essentially all accidents occur because someone, somewhere, failed to follow established procedures for some reason. Rig X appears to be doing a poor job of correcting reasons for those failures in 9 out of 10 accidents, and it is unlikely they will do better, in the long run, with the new procedure set by that one Type 3 plan.

Rig Y's supervisors are more likely to solve a problem than to ignore it. An average over 2.0 puts them in the range of permanently solving problems and making continuous improvements. If these numbers truly reflect rig supervisors' approach to correcting problems, Rig Y will not only have fewer accidents, they will also have fewer operational mishaps of any/sort.

Company personnel must do three things to correct the causes of accidents. (1) They must be aware of problems that result in unplanned events. (2) They must devise good corrective actions. (3) They must implement those corrective actions. The overall problem solving index according to the disclosure to measure performance factors in all three of these elements.

The problem solving index according to the disclosure takes into account a Problem Awareness Index, a Solutions or Planning Index and an Implementation Index. The product of these indices results in an objective uniform performance measurement that can be compared across individuals, departments, companies, divisions and even industries depending upon the scale of implementation.

Problem Awareness Index. Most accidents (as defined earlier) do not cause harm. This means that a supervisor or manager who only reports accidents that cause harm is missing (or failing to react to) the majority of his or her problems.

This index is computed from the numbers of accidents that could have caused significant harm (whether they did or not) and those that actually caused harm. In an example embodiment according to the disclosure, the index ranges from 0.25 to 1.0. The index can be changed depending upon the emphasis one wishes to give to the number of incidents that did not cause harm. Requirements are preset according to the activity being evaluated, but typically a group meets “awareness” standards if at least half their accident reports involve events that caused no harm, but there was the potential for significant harm. In this case, they receive full credit (Awareness Index=1.0). The index never drops below 0.25, though, even if the group reports zero “harmless” accidents. The index is expressed in Equation 1:

Iₐ=(2×Aₕ)/A Equation (1)

(Iₐ in an example embodiment is limited to a minimum of 0.25 and a maximum of 1.0)

Assume 10 accidents have been reported. If 5 to 10 caused little or no harm then the Awareness Index would be 1.0. If only 1 accident caused insignificant harm, the calculated Awareness Index would be 0.2, but it would be raised to 0.25, the minimum. In the example, assume that 4 of the 10 accidents were harmless according to preset criteria.

Solutions or Planning Index. The planning index is the weighted average of the Corrective Action plan types. Calculate the sum of A) (the number of Type 1's) B) (the number of Type 2's multiplied by 2); and C) (the number of Type 3's multiplied by 3). This sum is called the “Total Points”. The Total Points is divided by the Total Reports to obtain the Planning Index.

The Implementation Index is the percentage of plans actually implemented. Management verifies all Type 3 plans. The percentage of plans implemented is calculated by dividing the number of Type 3 plans actually implemented by the total number of Type 3 plans. If all Type 3 plans have been implemented then the percentage is 100%.

An important part of this measurement system is a requirement for personnel, usually management, to confirm that all Type 3 plans have indeed been implemented. Type 0 actions cannot be confirmed because they are not actually actions. Types 1 and 2 actions do not need confirmation because they are only single-use plans and make little or no difference for the long-term future. The only action plans that need confirmation are those rated Type 3. In the case of drilling rigs, a drilling engineer, superintendent, or line manager above the rig foreman can normally confirm that the action has been implemented with a telephone call, fax, or email.

This requirement forces line managers to be involved in the process of correcting the causes of accidents. In the drilling world, rig foremen are knowledgeable about drilling and may have long years of experience, but they usually have less training in management theory and practice than the line managers over them. Their superiors have a responsibility to help the rig foremen solve management problems, as in any management hierarchy. This index makes sure that happens, and it also makes sure that good corrective actions are not just written for the sake of a good score.

The Problem Solving Index (vPSI) according to the disclosure is then the product of the Planning, Awareness, and Implementation Indices. It will always be a number ranging from zero to 300.

The following guidelines are used to interpret the vPSI number:

0 to 100: Management's typical response to unplanned events such as accidents, is inaction. Expect accident rates to remain about the same or deteriorate.

100 to 200: Corrective actions are having at least a minor effect on safety performance, but accident reduction may be non-uniform, or better in some areas than in others.

200 to 300: Accident rates are certain to decline rapidly and safety performance continuously improve. Managers maintaining this rating are excellent candidates for promotion.

Corrective actions used for generating vPSI numbers typically come from accident reports, audits, and JSAs, but they can come from client visit reports, maintenance reports, help desk logs, or any database that identifies problems and thoroughly explains what action was taken to prevent that problem.

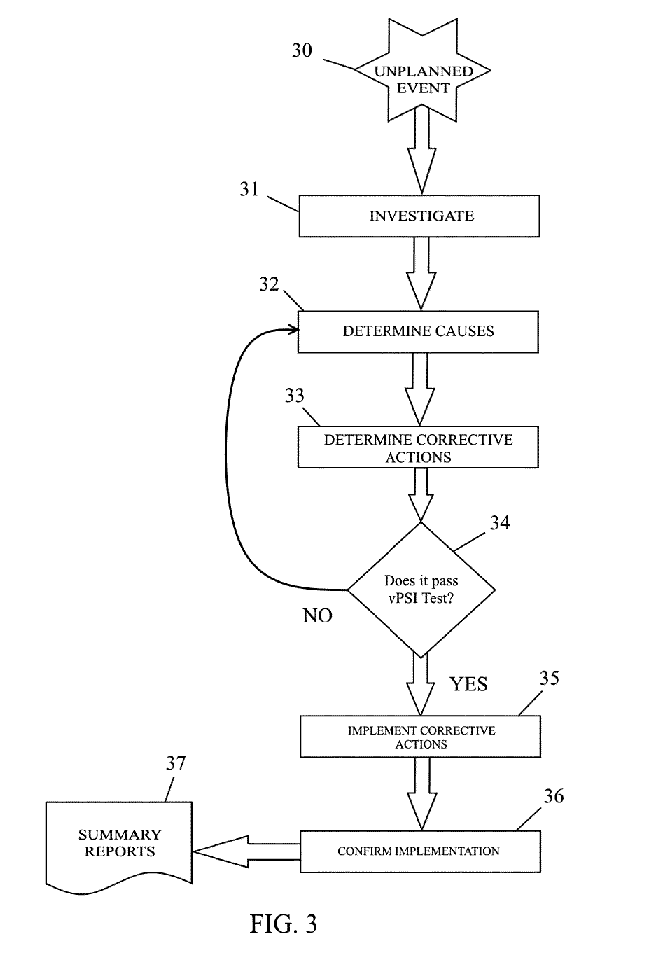

FIG. 3 shows a reporting process according to the disclosure. An unplanned event 30 occurs resulting in an investigation 31. The investigation 31 leads to a preliminary determination of causes 32 of the accident. Based upon the determination of causes 32 corrective actions are identified in step 33. The corrective actions are qualitatively analyzed at step 34 according to the disclosure. If the corrective action 33 is of an identifiable plan type then it is implemented in step 35. If the corrective action 33 does not meet the qualitative requirement then the process returns to a determination of causes 32. The determination of causes of the accident 30 is reevaluated and a new corrective action 33 is identified. After a corrective action has been implemented, the implementation is confirmed in step 36 resulting in a report 37.

A key aspect according to the disclosure is the identification of the corrective action to be taken after the cause has been determined. Some preliminary questions to ask regarding the corrective action are: 1) Is the corrective action an action item? 2) Does the corrective action meet the definition of a plan? and 3) Is the corrective action at least a Type 1 action from FIG. 7.

A corrective action is something that is done to ensure a change from old behavior to a predetermined new behavior. Simply identifying new behavior is not a corrective action. For example, in informal test of whether something is a corrective action is whether the corrective action will make sense if it is preceded with “I will . . . ,”; “I have . . . ,”; or “[someone] will . . . ”. A more formal test is whether the corrective action is a plan resulting in a pre-arranged schedule of events leading to attaining a predetermined objective. The Problem Solving Index (vPSI) according to the disclosure is an objective measurement of the efficacy the chosen corrective actions over a predetermined time period.

It is understood, with respect to corrective actions, that there are primarily two possible ways of causing something to happen: 1) doing it oneself, or 2) Delegating someone else to do it. Alternatively, one can make a speech and hope somebody follows the advice given in the speech. Advice, however, is not considered a corrective action. “Doing it yourself” is considered “operator” or “direct action”. This may accomplished with the help of assistants. This is considered a Type 1 corrective action. Getting someone else to do it can either be a supervisory or managerial event. A supervisory event is identified normally as a single-use plan, whereas a managerial event can be identified as multi-use plans.

Designation of a Type for a specific corrective action is an integral part of the disclosure. Two primary questions that should be asked when designating a Type for a corrective action, are “What is the Scope of the Corrective Action?” and “Does the corrective action delegate tasks, decisions or objectives?”

Regarding the scope of the corrective action, is it “Single Use” or “Multi Use”? If it is a “Multi Use” corrective action then it is more likely to be a Type 3 or Management type corrective action?

Regarding whether the corrective action delegates, if it delegates tasks then it is a Type 1. If it delegates decisions then it is a Type 2. If it delegates objectives then it is a Type 3.

Corrective actions must cause a change in the course of events. Something must happen as a result of the action that would not have happened without it. It is impossible to change laws of nature, so any corrective action must cause one or more changes in the acts of people. Therefore, devising or identifying corrective actions begins with a clear identification of current and desired acts of people.

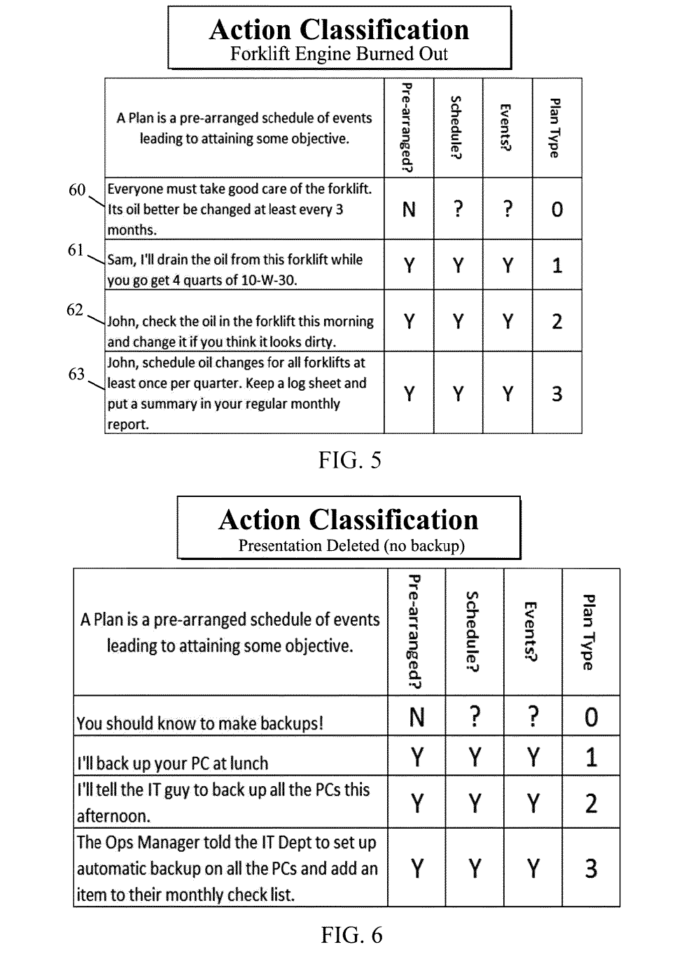

FIG. 5 is a table illustrating the classification of corrective actions that could be taken after an event. The event identified in this example is that a forklift engine has burned out. Row 60, identifies an example action to be taken as a result of the burned out engine. This action however, is merely advisory in nature with not set pre-arranged action. It would be classified as a plan type 0.

Row 61, identifies an immediate action taken by a the person establishing the corrective action and is classified as a plan type 1. Row 62 identifies a corrective action that delegates a specific action and is classified as a Type 2. Finally, row 63 identifies a managerial type action which will establish a plan leading to a long term solution and is classified as a Type 3 action.

Similarly, FIG. 6, is a table illustrating the classification of corrective action that could be taken after a computer presentation was deleted with no backup.

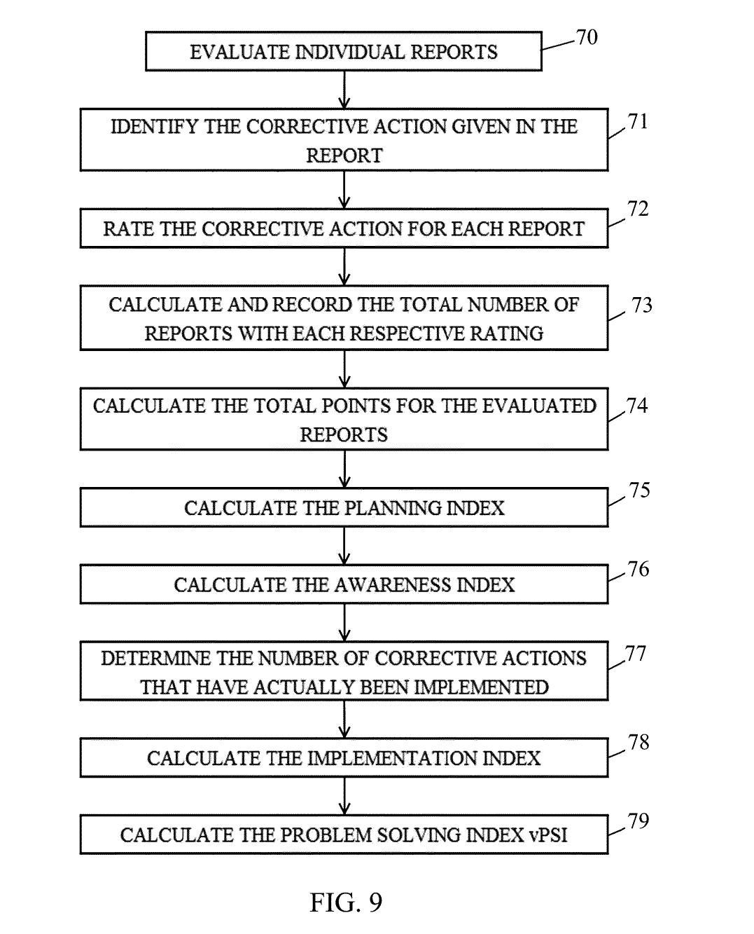

FIG. 9, is a flow chart identifying the steps of an example embodiment according to the disclosure. The process shown in FIG. 9, is to determine the vPSI, problem solving index, over a predetermined time period.

In the initial step 70 the individual accident reports identified during the set period of time are evaluated. This step considers only accidents where there was significant harm or where significant harm could have occurred under realistic different circumstances. In step 71, all corrective actions outlined in the report are identified. Next, in step 72 each report is rated by assigning the corrective action as Type 0, 1, 2, or 3, as set forth in FIG. 7. If the report has multiple corrective actions, then the report given the highest rating assigned to each of the corrective actions contained in the report. Next, in step 73 the total number of reports for each respective rating of Type 0, 1, 2, or 3 is calculated and recorded.

In step 74 the “Total Points” are calculated. “Points” are the respective rating multiplied by the total number of reports getting that rating, as calculated in step 73. For example, 5 reports of Type 1 would have Points of 5 (5*1). 6 reports of Type 2 would have Points of 12 (6*2). 4 reports of Type 3 would have Points of 12 (4*3). The Total Points in step 73 is calculated by the sum of the Points for each rating type.

Step 75 in FIG. 9 calculates the Planning Index. The Total Points from step 74 are divided by the total number of reports. The result is the Planning Index.

Step 76 in FIG. 9, calculates the Awareness Index. The awareness index is calculated by identifying the number of reports that resulted in insignificant actual harm but had the potential for serious harm and dividing this number by the total number of reports. The result is then multiplied by 2. If the resulting product is less than 0.25 then the Awareness Index is set to 0.25. If the resulting product is greater than 1, then the Awareness Index is set to 1. This will ensure that the Awareness Index is always between 0.25 and 1.

In step 77, a determination of the number of corrective actions that have actually been implemented. In this step, one should assume all Type 1 and 2 corrective actions have been implemented. Type 0 corrective actions represent a missed opportunity for a corrective action. Implementation of all Type 3 corrective actions should be confirmed. In step 78, the Implementation Index is calculated by the sum of all Type 1 and 2 corrective actions and the confirmed Type 3 corrective actions.

Finally, in step 79 in FIG. 9, the vPSI, Problem Solving Index, is calculated as the product of the Planning Index, (step 75), the Awareness Index, (step 76), and the Implementation Index (step 78).

FIG. 4, is an example input form according to a system of the disclosure, for calculating what has been called the vPSI, Problem Solving Index. The values from the steps identified in FIG. 9, can be incrementally placed in the form. An input from may be implemented using a Web page having an interface that is capable of accepting input from a user. The form can also be a program interface that accepts input from a user.

The objective of any safety program is accident minimization, but the number of accidents reported this year cannot predict future safety performance. The vPSI Problem Solving Index provides an objective analysis which will enable a company to measure problem solving improvement performance if the company continues the processes that it currently has in place.

A generally recognized principle of management theory holds that setting positive goals and targets to achieve is much more effective than setting targets to avoid. This positive management is possible by assigning a drilling rig, contractor, or any other organizational unit a minimum rating to achieve in some time. This amounts to rewarding people for solving problems as opposed to punishing them for having problems.

The vPSI system does not reward anyone for deceptive or incomplete reporting. In fact, the worst possible performance would come from reporting zero accidents. A vPSI of zero means no improvements have been made—possibly because no problems existed, but more likely because no problems were detected.

A group might go for some time without an accident that has potential for significant harm, particularly if the group is small, closed (minimal interaction with others), and has fixed low-risk routines. In that case, probably no real need for a vPSI rating exists. For larger groups, like drilling rigs with 50 or more people working around the clock, any month with zero incidents should be viewed with suspicion, and line managers should be investigating.

The vPSI measurement is completely under the control of the person or group being measured. In Examples 1 and 2, rig supervisors have total control over the corrective actions, but the extent of injury is a matter of chance outside their control. Rewards, positive or negative, based on OSHA definitions and rates involve a risk of being unfair.

Measuring corrective actions is an excellent vehicle for teaching basic management principles. People cannot obtain a good vPSI rating without learning problem-solving techniques that make their entire job easier, more productive, and more profitable. Supervisors who fully understand the differences between Types 1, 2, and 3 corrective actions will intuitively seek Type 3 plans for all their operational problems.

A typical jack-up drilling rig in the Gulf of Mexico may have up to about 20,000 man-hours exposure per month, but the OSHA Recordable Injury Rate is calculated per 200,000 man hours. A single recordable injury can have a big impact on the OSHA rate and the incentive for reclassifying or hiding injuries is unavoidable. Forecasts, trends, and other statistical analyses are unreliable when they are based on a small number of data points, particularly when those points are highly susceptible to “spin doctoring” or “creative accounting.” The vPSI system includes many more data points, and is immune to the creative accounting problem.

Accordingly, contractors, rigs, or organizational units that maintain a vPSI over 200 will have made substantial improvement in their probability of not having accidents.

Simply posting vPSI ratings will rapidly improve safety performance by involving line managers in official or unofficial contests where “winning” comes from helping the rig foremen make long-lasting improvements.

Ultimately, contractors with the best vPSI rating will also perform best in all operational areas, such as closeness to targets, minimum down time, and standard management ratios, like net profit or return on investment.

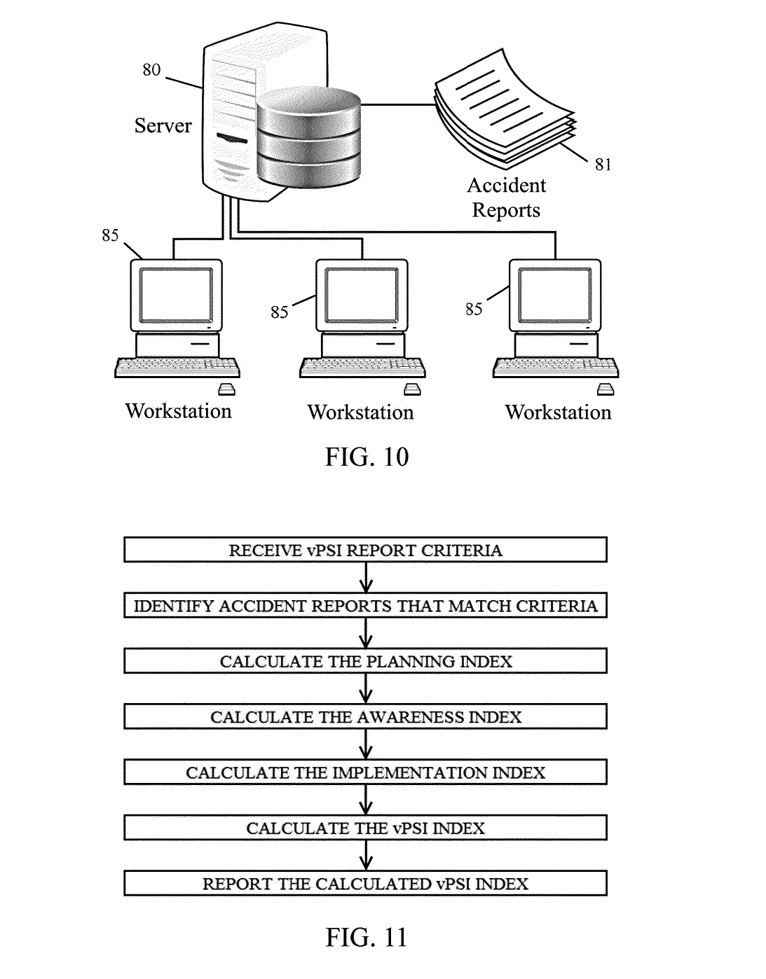

Another example embodiment according to the disclosure is shown in FIG. 10, as a system for efficiently and automatically implementing the Problem Solving Index according to the disclosure. A server 80 having a data store 81 accumulates information relating to accident reports. Server 80 and data store 81 may implement a database system for storing and retrieving data related to accident reports. Server 80 can be any general purpose computer having a central processing unit and a storage device. Data store 81 can be a hard drive, database management system stored on the hard drive, are even one or more data files stored in the file system implemented on the hard drive. Data store 81 may also be a networked database that is remote from server 80 or even a network storage device that is connected to server 80 over a network, either local or even the Internet.

Server 81 receives information related to the accident report including such things as the type of accident, date and time of the accident, the severity of the accident, the type of harm caused by the accident including the severity of physical and other harm caused to humans. Moreover, for each accident report stored in data store 81, a corrective action Type 0, 1, 2, or 3, is also stored. If the corrective action type is Type 3, then a confirmation field is also maintained and is updated when implementation of the corrective action Type 3 is completed.

Moreover, for each accident report a multilevel relational association is maintained throughout the organization. For example, the supervisor, manager, division, group, etc. that is related to this accident report is maintained. This relational aspect is important to conduct vPSI analyses at differing levels throughout the organization. Divisions within the organization can then be compared using their respective vPSI numbers. The steps identified in FIG. 9, would initially include an identification of all accident reports for a respective division during a predetermined time period. The process would be implemented for each identified division resulting in a vPSI number for the respective division. Similarly, the system would enable the comparison of supervisors and managers who are being considered for promotion. The comparison using the vPSI number would be an objective comparison.

Information gathering and reporting according to the system could be accomplished either locally at server 80 or through remote interfaces located at workstations 85. The remote workstations 85 could be maintained within a company's local area network running client software to interface with data store 81. Alternatively, workstations 85 could be connected via the Internet, a LAN, WAN, or other network type. The interface into data store 81, could be via a web page containing fields to enter information regarding accident reports or to identify a criteria for obtaining a vPSI number as well as to receive reporting of the vPSI number.

Another example embodiment according to the disclosures, involves the rating of a corrective action. When entering information related to an accident report in the system according to the disclosure, it is necessary to rate the corrective action as Type 0, 1, 2, or 3. In one embodiment according to the disclosure, this rating would be input data store for subsequent use in calculating the vPSI index. In an example embodiment in this disclosure, rather than enable the user to input the rating, the user is presented with objective questions regarding the corrective action, including “What is the Scope of the Corrective Action?” and “Does the corrective action delegate tasks, decisions or objectives?”. The system presents the user with a set of possible answers and explanations for selection. The system will then determine the rating for the corrective action based upon the answers given. If there are multiple corrective actions for the accident report then the system will rate the accident report with the greatest Type given to one of the corrective actions in the report.

The primary purpose and improvement provided by the system is the objective maintenance of data related to all areas of the organization and the ease with which these areas can be compared to each other. A vPSI report for comparison purposes can be easily generated by a request. As shown in FIGS. 10 and 11, the server 80 accepts a request for reporting either locally or from a workstation 85. The server 80 receives as part of the request criteria identifying a time period and organizational level. The organizational level may be range from an employee such as an individual supervisor to the entire organization for example. Moreover, the system could be implemented on an industry wide level where participating organizations would provide the necessary data.

After the server 80 receives the report criteria, server 80 accesses data store 81 and identifies all accident reports that match the criteria. Server 80 calculates the Planning Index according to the disclosure using the identified accident reports and the data related to the accident report. Server 80 calculates the Awareness Index according to the disclosure using the identified accident reports and the data related to the accident reports. Server 80 calculates the Implementation Index according to the disclosure using the accident reports and the data related to the accident reports. Finally, server 80 calculates the vPSI index according to the disclosure and reports the result.

It is understood that the system enables the objective comparison of entities within an organization or outside of an organization. Indeed, the system can be implemented such that independent contractors could maintain information within the system and request a certified vPSI index when bidding on a job. The system according to the disclosure maintains information related to the independent contractor and would calculate the vPSI number according to the disclosure with respect to the independent contractor. The certification of the vPSI number would maintain the objectiveness of the index and enable an organization to confidently choose a contractor based upon a higher vPSI number.

While it is understood that the foregoing is directed to example embodiments of the system and methods described herein according to the disclosure, other and further embodiments of the disclosure may be devised without departing from the basic scope thereof, and the scope of the invention is determined by the claims that follow.

What is claimed is:

1. A non-transitory computer readable medium with computer instructions tangibly embodied thereon that when executed by a computer connected to an electronic computer network perform the method steps comprising:
establishing a connection to the electronic computer network to enable the receipt of information from one or more computers connected to the electronic computer network;
receiving from a first computer over the electronic computer network one or more data records each associated with an accident related report from a group of one or more accident related reports, each data record including a data field identifying an entity, identifying whether the accident resulted in harm, identifying whether the accident had the potential to result in harm, and including one or more data fields that each contain a description of a corrective action taken in response to the accident described in the associated accident related report;
storing each received data record in a database in an electronic storage medium;
upon receiving an initiation command automatically performing the following steps:
retrieving one or more data records associated with an entity from the database;
for each the data record performing the following steps:
a. retrieving each of the one or more corrective actions;
b. for each retrieved corrective action,
automatically assigning an action type from the group of no action, direct action, supervisory action, and management action to each of the one or more corrective actions,
posing a first question which asks if the retrieved corrective action is implemented once or is implemented multiple times,
posing a second question which asks if the retrieved corrective action delegates specific tasks or delegates decision making authority,
automatically assigning the retrieved corrective action in each report an assigned value of 0, 1, 2 or 3, and
storing the assigned action type and the assigned value of 0, 1, 2, or 3 in association with each retrieved data record.
c. for each of the one or more data records, analyzing the one or more retrieved corrective actions, identifying the highest assigned action type according to the value order of management action, supervisory action, direct action and no action, assigning a rating value based upon the identified highest assigned action type, and storing the rating value in the data record, wherein a management action has the greatest rating value and no action has the least rating value and data record receives a value rating which is equal to the value of the action type having the greatest value;
d. retrieving the rating values from each of the retrieved data record and calculating a planning index by calculating a weighted average of the rating values;
e. associating the planning index with the entity and storing the planning index in an entity data record in the database;
f. calculating a first number representing a total number of the retrieved data records;
g. calculating a second number representing a total number of data records identified as having the potential for harm but did not result in harm;
h. calculating an awareness index by calculating the ratio of the second number to the first number and multiplying by two;
i. associating the awareness index with the entity and storing the awareness index in the entity data record in the database;
j. for each the retrieved corrective action automatically calculating an implementation index by calculating a sum of the total number of assigned action types from the group of: direct action, supervisory action, and management action that have been confirmed as implemented and dividing the sum of the total number of assigned action types by the total number of the retrieved data records;
k. associating the implementation index with the entity and storing the implementation index in the entity data record in the database;
l. retrieving from the entity data record the planning index, the awareness index and the implementation index and calculating the product of the planning index, the awareness index, and the implementation index; and
m. generating a report which includes the awareness index, the implementation index, the planning index and the product.

2. The non-transitory computer readable medium of claim 1, further performing the step of adjusting the awareness index to be within the range of 0.25 and 1.0, prior to calculating the product.

3. The method of claim 1, further comprising the steps of:
automatically assigning the corrective action the assigned value of 3 if the answer to the first question specifies that the corrective action will be implemented multiple times;
automatically assigning the corrective action an assigned value of 2 if the answer to the second question specifies that the corrective action delegates decision making authority;
automatically assigning the corrective action an assigned value of 1 if the answer to the second question specifies that the corrective action delegates specific tasks; and
automatically assigning the corrective action an assigned value of 0 if the corrective action is not an event or action that causes a change or a result.

4. The method of claim 1, further comprising the steps of:
investigating an accident;
identifying the causes of the accident;
identifying a corrective action that reduces or prevents future accidents;
analyzing the corrective action to determining if:
a. the corrective action is assigned to be performed by a person identifying the corrective action or delegated to another person;
b. the corrective action is scheduled to occur; and
c. the corrective action is an event or action that causes a change or a result;
implementing the corrective action;
confirming implementation of the corrective action; and
generating an accident related report for each accident, wherein the accident related report comprises information related to implementation of the corrective action.

5. A method for generating a problem solving index for evaluating problem solving measures and corrective actions, comprising the steps of:
investigating an unplanned event;
identifying the causes of the unplanned event;
identifying a corrective action that reduces or prevents future unplanned events;
implementing the corrective action;
confirming implementation of the corrective action;
preparing a report for each unplanned event, wherein the report comprises information related to implementation of the corrective action;
calculating a total number of reports by calculating the sum of all reports prepared for unplanned events that caused harm or had potential to cause harm;
assigning the corrective action in each report an assigned value of 0, 1, 2, or 3;
calculating a planning index;
calculating an awareness index;
calculating an implementation index; and
calculating a problem solving index.

6. The method of claim 5, wherein the step of calculating the planning index comprises:
calculating a number of reports with each assigned value;
calculating total points by multiplying the number of reports with each assigned value by the assigned value; and
dividing the total points by the total number of reports.

7. The method of claim 6, wherein the step of calculating the awareness index comprises:
calculating a total number of no-harm reports by calculating the sum of all reports prepared for unplanned events that resulted in no harm or insignificant harm;
calculating a quotient by dividing the total number of no-harm reports by the total number of reports; and
multiplying the quotient by two.

8. The method of claim 7, further comprising the step of adjusting the awareness index to a minimum value of 0.25 and a maximum value of 1.0.

9. The method of claim 8, wherein the step of calculating the implementation index comprises:
calculating a sum of reports having:
corrective actions with the assigned value of 1;
corrective actions with the assigned value of 2; and
corrective actions with the assigned value of 3 that have been confirmed as implemented;
dividing the sum of reports by the total number of reports.

10. The method of claim 9, wherein the step of calculating the problem solving index comprises calculating the product or the planning index, the awareness index, and the implementation index.

11. The method of claim 10, wherein the step of assigning the corrective action in each report the assigned value of 0, 1, 2, or 3 comprises:
analyzing the corrective action in each report;
assigning the corrective action the assigned value of 3 if the corrective action will be implemented multiple times;
assigning the corrective action the assigned value of 2 if the corrective action is implemented a single time and is delegated to another person with discretion on implementation;
assigning the corrective action the assigned value of 1 if the corrective action is implemented a single time and is performed by the person preparing the report or delegated to another person to perform with no discretion on implementation; and
assigning the corrective action an assigned value of 0 if the corrective action is not an event or action that causes a change or a result.

12. The method of claim 10, wherein the step of assigning the corrective action in each report the assigned value of 0, 1, 2, or 3 comprises:
analyzing the corrective action in each report;
posing a first question which ask if the corrective action is implemented once or multiple times;
posing a second question which asks if the corrective action delegates specific tasks or decision making authority;
assigning the corrective action in each report the assigned value of 0, 1, 2 or 3 based on answers to the first and second questions.

13. The method of claim 12, further comprising the steps of:
assigning the corrective action the assigned value of 3 if the answer to the first question specifies that the corrective action will be implemented multiple times;
assigning the corrective action an assigned value of 2 if the answer to the second question specifies that the corrective action delegates decision making authority;
assigning the corrective action an assigned value of 1 if the answer to the second question specifies that the corrective action delegates specific tasks;
assigning the corrective action an assigned value of 0 if the corrective action is not an event or action that causes a change or a result.

14. The method of claim 11, further comprises the step of analyzing the corrective action to determine if:
the corrective action is assigned to be performed by a person identifying the corrective action or delegated to another person;
the corrective action is scheduled to occur; and
the corrective action is an event or action that causes a change or a result.
